(19) United States
(12) Patent Application Publication
(10) Pub. No.: US 2022/0081339 A1
(43) Pub. Date: Mar. 17, 2022

(54) SYSTEM FOR COAL ASH CLEANUP

(71) Applicants: Joseph C. Gannon, Glenwood, MD (US); Jarrod Rice, Spring, TX (US)

(72) Inventors: Joseph C. Gannon, Glenwood, MD (US); Jarrod Rice, Spring, TX (US)

(21) Appl. No.: 17/473,697

(22) Filed: Sep. 13, 2021

Related U.S. Application Data
(60) Provisional application No. 63/077,825, filed on Sep. 14, 2020.

(51) Int. Cl. C02F 11/121; C02F 1/00

(52) U.S. Cl. CPC C02F 11/121; C02F 2103/007; C02F 1/004

(57) ABSTRACT

A system for cleanup of coal ash mixed with water from an original settling pond comprises a dredge configured to lift the coal ash mixed with water from beneath the water level, a transport line configured to receive the coal ash mixed with water from the dredge and move the coal ash mixed with water out of the original settling pond, and at least one designed dewatering cell configured to receive the coal ash mixed with water from the transport line. A bulk solids handler is configured to remove the coal ash from the dewatering cell after a predetermined portion of the water has been removed, and a conveyor is configured to receive the removed coal ash from the bulk solids handler and transport the coal ash to a predetermined delivery point.

### CROSS-REFERENCE TO RELATED APPLICATIONS

This application claims benefit of U.S. Provisional Application No. 63/077,825, filed Sep. 14, 2020, entitled SYSTEM FOR COAL ASH CLEANUP (Atty. Dkt. No. CLRC60-35003), which is incorporated by reference herein in its entirety.

### TECHNICAL FIELD

The following disclosure relates to systems for coal ash cleanup. In particular, systems for handling coal ash in wet and dry states are disclosed, systems for dewatering coal ash are disclosed, systems for loading coal ash onto transport systems are disclosed; systems for transporting coal ash from one geographic location to another are disclosed; systems for solids removal from coal ash are disclosed and systems for processing of the solids removed from coal ash are disclosed.

### BACKGROUND

In recent years, the waste coal ash from coal-fired power plants has been determined to be an environmental and health issue. Traditionally, the coal ash was settled out in a pond (also known as called a “coal ash basin” or “surface impoundment”) over the years of the coal power plant's operation. According to the United States Environmental Protection Agency (“EPA”), unused coal ash in the U.S. is currently disposed of in more than 735 ponds averaging more than 50 acres in size with an average depth of 6 meters, and in more than 310 landfill sites averaging 120 acres in size and an average depth of 12 meters. New laws, rules, and/or regulations have driven many plants to move the coal ash from the settling ponds to safer long term storage and/or beneficial reuse.

In many cases, the coal ash in the settling pond is “wet,” i.e., associated with water that interferes with efficient handling. Examples of wet coal ash include, but are not limited to, coal ash submerged under a free surface of water, coal ash submerged by an underground water level, coal ash mixed with water, coal ash/water slurry, coal ash saturated with water and coal ash having a undesirable moisture level. The coal ash to be removed from a pond must be dry enough to meet project requirements, which oftentimes include being dry enough to be transported over roads or on rail cars. Also, additional water adds to the weight of hauling/disposal.

The main method of removing the coal ash to date has been to mechanically excavate for dry material using excavators, front end loaders, and trucks.

Many of these settling ponds are irregular configuration as they were created by creating a berm or dam at a low point, and the settling pond filled into the contours of the land. This can make for difficulty in efficient excavating and/or dewatering. Oftentimes, the coal ash has been dewatered to dry it enough for the excavators and front-end loaders to remove the material. This is both costly and time-consuming.

As previously discussed, many of these settling ponds are very large. Working out on the coal ash can be very dangerous as the coal ash can be quite unstable. There have been several fatalities of workers out on the coal ash.

These conditions can make it hard to optimize production and conduct the current methods of excavation is a safe manner.

### SUMMARY

The current disclosure relates to systems for coal ash cleanup that provide improvements in safety, efficiency and/or productivity over conventional cleanup systems.

In one aspect, dry ash either in the plant's original settling pond or the dewatering cell/basin/pond, is removed using a continuous mining/loading unit. These units are adapted from apparatus originally developed for underground mining. By adapting this technology to the cleanup of coal ash ponds with conveyors, the efficiency of coal ash cleanup operations and safety are increased. On the original settling pond, these units can be remotely or autonomously operated to prevent personnel from having to be out on the unstable coal ash which is a major safety improvement over human operators in excavators, frontend loaders, and/or trucks driving over the coal ash.

In another aspect, a purpose-designed dewatering basin/pond (also called a “dewatering cell” or “cell”) is provided so that the dewatering process can be controlled and optimized allowing for more efficient operations. Some embodiments may use multiple dewatering cells. Given the designed nature of the dewatering cell, loading can also be optimized versus the inconsistent conditions that can be encountered in the original settling ponds. In some embodiments, a continuous miner and conveyor and/or a continuous loader and conveyor are used to remove the coal ash to allow for a very streamlined and continuous means of excavating and loading of the ash from the dewatering cell, which improves reliability and the speed of operations. In other embodiments, the coal ash removal can be performed by a continuous or non-continuous bulk solids handler including, but not limited to an excavator, a front end loader, a ditching machine, a trenching machine, a snow blower or another bulk solids handler.

These removal projects benefit from a more controlled operation reducing the times material must be handled by people and machines, and reducing the drying time for the material to be transported/disposed of.

In some embodiments, even greater efficiencies can be achieved by using solids separations equipment on the ash slurry removed from the original pond before it is placed in the dewatering cell. This solids removal equipment removes and dries a portion of the coal ash solids from the associated water before the dewatering basin/pond(s). This reduces the volume of coal ash that must be dried in the dewatering basin/pond(s).

While a continuous miner/conveyor arrangement and/or a continuous loader/conveyor arrangement is efficient and safe, in some embodiments the excavating and loading from the dewatering cell can still be done using a continuous or non-continuous bulk solids handler including, but not limited to an excavator, a front end loader, a ditching machine, a trenching machine, a snow blower or other bulk solids handler type of machinery if desired and still obtain benefits over standard excavation/dewatering methods.

Three aspects of the invention are as follows: 1) “wet process;” 2) “dry process;” and 3) “hybrid process.” In the wet process, the coal ash or other by-product from the production of power in a power plant in the original pond is submerged under water, saturated with water or otherwise too wet to practically handle as a solid. Instead, the coal ash and water mixture is preferably handled as a liquid or a slurry. The coal ash and water mixture can be dredged, sluiced, or dumped from the original pond in the wet process ending in a dry stackable and transportable form. In the dry process, the coal ash in the original pond is dry enough to be handled as a solid that is dry stackable and transportable. Such dry coal ash can be picked up and conveyed through a mechanical belt and paddle conveyor system(s) to a holding area or directly into trucks. The dry process can be substantially similar to the process used for handling dewatered coal ash from the dewatering cell/basin/pond after dewatering. In the hybrid process, the coal ash in a first portion of the original pond is dry (i.e., as in the dry process) while the coal ash in a second portion is of the original pond is wet (i.e., as in the wet process). In some embodiments of the hybrid process, the first portion can be in a different geographic area of the original pond from the second portion. In other embodiments of the hybrid process, the first portion can overlie the second portion in the same geographic area of the original pond. In the hybrid process, dry process steps are used to remove some or all of the first portion of the coal ash, and wet process steps are used to remove some or all of the second portion of the coal ash. In some embodiments of the hybrid process, the first and second portions can be processed sequentially, whereas in other embodiments, the first and second portions can be processed concurrently.

In some aspects of the wet process, the coal ash slurry is moved from the original pond to a dewatering cell where the ash is dewatered to the desired dryness. The dewatering cell/basin/pond can be formed above-ground, in-ground, e.g., by excavation of suitable dimensions, and/or using existing geographic features, such as depressions having suitable dimensions meeting design requirements. The dewatering cell/basin/pond can be formed from materials including, but not limited to, dirt or compacted dirt, gravel or compacted gravel, soil or compacted soil, concrete, steel, or coal ash or compacted coal ash. The dewatering cell/basin/pond can be designed to assist or enhance the dewatering process with additional dewatering features. Examples of such features that can be added to the dewatering cell to help dewater the ash include, but are not limited to: i) a liner; ii) a leachate system; iii) a vacuum system; iv) well points for liquid removal; and/or v) a skimmer. A dewatering cell formed using off-site materials including, but not limited to, gravel, clay, concrete and/or steel brought to the site and/or including any of the aforementioned featured including, but not limited to, liners, leachate systems, a vacuum systems, well points and/or skimmers to assist in dewatering the coal ash is considered a designed dewatering cell.

The determination of the optimum design for the dewatering cell/basin/pond can be based upon site specific conditions such as real estate, topography, weather, etc. Depending upon weather conditions, the basin/pond(s) may or may not be covered.

In some embodiments of the wet process, the ash removed from the original pond can either be: 1) deposited directly into the dewatering cell/basin/pond; or 2) can go through a solids separation process first to remove some of the ash prior to deposition in the dewatering cell/basin/pond. Which of these alternatives is preferred for a particular site/project is dependent on the available space, weather conditions, proximity of disposal location, timeline, or other reasons.

In some embodiments, the coal ash is removed from an original settling pond either by a hydraulic dredge which can either be directly operated, remotely operated or autonomously operated. The dredge can a hydraulic suction-type dredge, a continuous bucket-type dredge or other type of dredge.

In embodiments where the coal ash goes through a solids removal/mechanical drying process (i.e., prior to deposition into the dewatering cell/basin/pond), the solids removal/mechanical drying system can comprise, but is not limited to, one or more of the following types of equipment,: a) bulk material screeners for rocks, debris, etc.; b) screen and/or trummel units; c) hydrocyclones; d) centrifuges; e) filter belts; f) filters presses; and/or g) chemical injectors for chemicals such as coagulants or flocculent to help in the separation. The solids removal process can further comprise sizing of the removed ash particles for differentiated use/beneficiation and/or disposal.

In another aspect, the coal ash removed from the original pond may be moved via trucks/excavators. The removed coal ash may be moved directly to a dewatering cell/basin/pond or it may be sent to a solids separation process. In such embodiments where the coal ash goes through a solids removal/mechanical drying process (i.e., prior to deposition into the dewatering cell/basin/pond), the solids removal/mechanical drying system can comprise, but is not limited to, one or more of the following types of equipment: a) a bulk material screener for rocks, debris, etc.; b) a screen and/or trummel unit; c) a hydrocyclone; d) a centrifuge; e) a filter belt; f) a filters press; and/or g) a chemical injector for chemicals such as coagulants or flocculent to help in the separation. The solids removal process for the coal ash can further comprise sizing of the removed ash particles for differentiated use/beneficiation and/or disposal.

In still other aspects, the coal ash removed from the original pond may be transported as a paste. The removed coal ash paste may be moved directly to a dewatering cell/basin/pond or it may be sent to a solids separation process. In such embodiments where the coal ash paste goes through a solids removal/mechanical drying process (i.e., prior to deposition into the dewatering cell/basin/pond), the solids removal/mechanical drying system can comprise, but is not limited to, one or more of the following types of equipment: a) a bulk material screener for rocks, debris, etc.; b) a screen and/or trummel unit; c) a hydrocyclone; d) a centrifuge; e) a filter belt; f) a filter press; and/or g) a chemical injector for chemicals such as coagulants or flocculents to help in the separation. The solids removal process for the coal ash paste can further comprise sizing of the removed ash particles for differentiated use/beneficiation and/or disposal.

In further aspects, the water from the dewatering process, e.g., from the solid separation process (if used) and/or from the dewatering cell/basins/pond can be: a) returned to the original settling pond where the coal ash slurry originated; b) sent for onsite reuse if the need is available; c) sent for offsite reuse; and/or d) discharged to surface waters or sanitary sewer. In all of the above processes, the process can further comprise treating the water to the extent needed depending on water quality and water quality objectives.

For aspects involving the dry method, sending the coal ash to a dewatering cell/basin/pond may not be required.

When the coal ash has reached the desired dryness, whether in the dewatering cell/basis/bond (i.e., in wet process) or in the original pond (i.e., in dry process), the dry coal ash can be loaded for further processing using the following equipment and processes: a) using a front end loader; b) using an excavator; c) using a continuous miner or continuous loader; and/or d) using a continuous or non-continuous bulk solids handler.

The loading processes can transport the dry ash to a conveyor process that transports the ash to one of: a) directly into a truck or rail car for transport to the disposal/reuse location; b) a stockpile area where it can be loaded in to trucks or rail cars either by excavator or front end loading type of equipment; c) a top loading storage bin to drop the ash into transport trucks or rail cars; d) directly to the disposal/reuse storage location.

The aforesaid conveyor process can use either be a flexible conveyor apparatus or a static conveyor apparatus. The aforesaid continuous miner, continuous loader, conveyor and/or bulk solids handler can either be: a) directly operated; b) remotely operated; or c) autonomously operated via computer-controlled program/setup.

If desired the material from the continuous miner, the continuous loader and/or the bulk solids handler can be mixed into a paste for transport to the disposal/reuse location.

In another aspect, a system is provided for cleanup of coal ash mixed with water from an original settling pond, wherein the coal ash lies under a water level in the settling pond. The system comprises a dredge configured to lift the coal ash mixed with water from beneath the water level, a transport line configured to receive the coal ash mixed with water from the dredge and move the coal ash mixed with water out of the original settling pond, and at least one designed dewatering cell configured to receive the coal ash mixed with water from the transport line. One of a continuous miner, a continuous loader and/or a bulk solids handler is configured to remove the coal ash from the dewatering cell after a predetermined portion of the water has been removed, and a conveyor is configured to receive the removed coal ash from the continuous miner, continuous loader and/or bulk solids handler and transport the coal ash to a predetermined delivery point.

In one embodiment, the dredge is a hydraulic suction-type dredge.

In another embodiment, the dredge is a continuous bucket-type dredge.

In another embodiment, the dredge is a non-continuous bucket-type dredge.

In yet another embodiment, the system for cleanup of coal ash further comprises a solids removal plant configured to receive the coal ash mixed with water from the transport line, remove a first portion of the coal ash from coal ash mixed with water, to discharge the first portion of the coal ash into a secondary solids line, and to deliver the remainder of the coal ash mixed with water to the at least one designed dewatering cell.

In still another embodiment, the solids removal plant is configured to remove the first portion of the coal ash from the coal ash mixed with water based on a predetermined size range of particles to be included in the first portion of the coal ash.

In a further embodiment, the solids removal plant includes one of more of a bulk material screeners for rocks and debris, a screen and/or trummel unit, a hydrocyclone, a centrifuge, a filter belt, a filter press, and a chemical injector for coagulants or flocculents.

In a still further embodiment, the at least one designed dewatering cell is formed of one or more of dirt, gravel, soil, compacted soil, concrete, steel, or coal ash.

In another embodiment, the at least one designed dewatering cell further includes one or more of a liner; a leachate system, a vacuum system, one or more well points, and one or more liquid skimmers.

In yet another embodiment, the system for cleanup of coal ash further comprises a water return line configured to return water removed from the coal ash in the at least one designed dewatering cell back to the original settling pond.

In another aspect, a system is provided for cleanup of coal ash from an original settling pond. The system comprises a continuous miner configured to remove the coal ash from the original settling pond after a predetermined portion of the water has been removed and a conveyor configured to receive the removed coal ash from the continuous miner and transport the coal ash to a predetermined delivery point.

In yet another aspect, a method for cleanup of coal ash mixed with water from an original settling pond is provided, wherein the coal ash lies under a water level in the settling pond. The method comprises providing a dewatering cell configured to receive coal ash mixed with water, the dewatering cell being disposed a distance from an original settling pond. The coal ash mixed with water in the original settling pond is lifted from beneath a water level. The coal ash mixed with water from the original settling pond is received at a first point outside the original settling pond. The coal ash mixed with water is moved from the first point to a second point disposed at the dewatering cell. The coal ash mixed with water received at the second point is deposited into the dewatering cell. Using the dewatering cell, a predetermined portion of the water from the deposited coal ash mixed with water is removed, leaving a bed of dewatered coal ash in the dewatering cell. The dewatered coal ash from the bed of dewatered coal ash in the dewatering cell is removed using at least one of a continuous miner, a continuous loader or a bulk solids handler driving on the surface of the bed. The removed dewatered coal ash from the dewatering cell is transported to a predetermined delivery point outside the dewatering cell.

In one embodiment, receiving the coal ash mixed with water from the original settling pond at a first point outside the original settling pond further comprises: removing a first portion of the coal ash from coal ash mixed with water; discharging the removed first portion of the coal ash into a secondary solids line; and discharging the remainder of the coal ash mixed with water to the second point.

In another embodiment, removing a first portion of the coal ash from coal ash mixed with water further comprises removing the first portion of the coal ash from the coal ash mixed with water based on a predetermined size range of particles to be included in the first portion of the coal ash.

In yet another embodiment, removing a first portion of the coal ash from coal ash mixed with water further comprises using at least one of a bulk material screeners for rocks and debris, a screen unit, a trummel unit, a hydrocyclone, a centrifuge, a filter belt, a filter press or a chemical injector for coagulants or flocculents.

In still another embodiment, providing a dewatering cell further comprises constructing a water retaining structure at a site, wherein the structure is formed at least partially of at least one of dirt, gravel, clay, soil, compacted soil, concrete, steel, or coal ash brought to the site.

In a further embodiment, providing a dewatering cell further comprises constructing a water retaining structure including at least one of a liner; a leachate system, a vacuum system, a liquid removal well, or a liquid skimmer.

In a still further embodiment, the method further comprises returning the portion of water removed from the coal ash mixed with water at the dewatering cell back to the original settling pond.

In yet another aspect, a bulk solids handler is provided for removing coal ash from a bed of dewatered coal ash. The handler comprises a body mounted on a set of wheels or tracks configured to move across a bed of dewatered coal ash. A cutter apparatus is attached to the front of the body and configured for cutting coal ash from the bed of dewatered coal ash as the body moves forward across the bed of dewatered coal ash. An inlet scoop is attached to the front of the body for receiving coal ash cut from the bed of dewatered coal ash. A solids conveyor system is attached to the body for moving the coal ash from the inlet scoop to a discharge outlet, wherein the discharge outlet is configured for dumping the coal ash into an adjacent transport apparatus.

In one embodiment, at least one of the cutter apparatus and the inlet scoop is attached to the front of the body with an adjustable-angle mount defining a mounting angle. Selectively changing the mounting angle selectively changes a depth of cut into the bed of dewatered coal ash by the bulk solids handler.

In another embodiment, the cutter apparatus further comprises a rotating reel having a plurality of solids removal implements mounted thereon for removing coal ash from the dewatered coal ash bed and directing the removed coal ash into the inlet scoop.

In still another embodiment, the solids conveyor system comprises a coal ash bin dispose within the body and configured to receive coal ash from the inlet scoop. The coal ash bin defines an internal storage volume for storing a quantity coal ash. An elevator extends between the coal ash bin and the discharge outlet for moving coal ash from the coal ash bin to the discharge outlet. The throughput of the elevator can be adjusted to selectively increase or selectively decrease the quantity of coal ash stored in the coal ash bin during operation of the handler.

### BRIEF DESCRIPTION OF THE DRAWINGS

For a more complete understanding, reference is now made to the following description taken in conjunction with the accompanying Drawings in which:

FIG. 1 is a schematic diagram of a system for coal ash pond cleanup in accordance with one aspect of the current invention;

FIG. 2 is a schematic diagram of a system for coal ash pond cleanup in accordance with another aspect of the invention;

FIG. 3 is an exemplary continuous miner used in some aspects of the invention;

FIG. 4 is an exemplary flexible conveyor train used in some aspects of the invention;

FIG. 5 is an exemplary continuous loader used in some aspects for the invention;

FIG. 6 shows a new bulk solids handler for loading dewatered coal ash from a dewatering cell according to another aspect;

FIG. 7 shows another embodiment of a new bulk solids handler for loading and conveying dewatered coal ash from a dewatering cell; and

FIG. 8. is a block diagram of a method for coal ash cleanup in accordance with another aspect.

### DETAILED DESCRIPTION

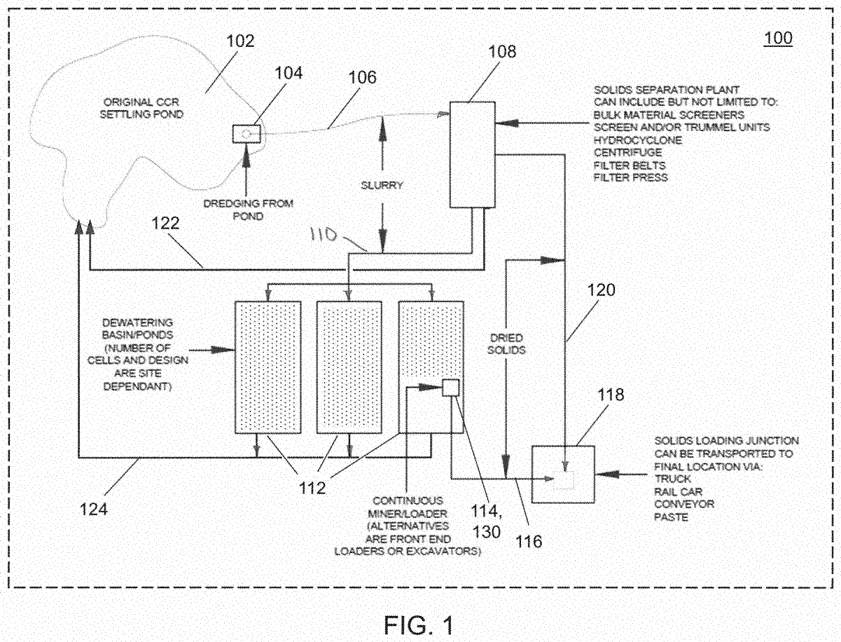

Referring first to FIG. 1, there is illustrated a schematic diagram of a system for coal ash cleanup 100 from an original settling pond 102. In this case, the original settling pond 102 contains a coal ash and water mixture that is too wet to be handled as a solid. The system 100 of this embodiment includes a dredging apparatus 104 for removing the coal ash and water mixture/slurry from the original pond 102 and discharging it into a slurry transport line 106. The dredging apparatus 104 can be directly operated by a human operator, remotely operated (with optional teleoperation) by a human operator or autonomously by on-board or remote computer operator (with optional machine vision). The slurry transportation line 106 can be a pipe, a sluice or dumping by discrete transport carriers. Optionally, a solids separation plant 108 is provided to receive the coal ash slurry from the transport line 106. The solids separation plant 108 can remove solids based on size and/or mechanically partially dewater the coal ash slurry. The solids removal/mechanical drying system 108 can comprise, but is not limited to, one or more of the following types of equipment: a) bulk material screeners for rocks, debris, etc.; b) screen and/or trummel units; c) hydrocyclones; d) centrifuges; e) filter belts; f) filters presses; and/or g) chemical injectors for chemicals such as coagulants or flocculent to help in the separation.

The coal ash slurry from the transport line 106, whether direct or partially dewatered by the solids separation plant 108, is received by slurry discharge line 110 and delivered to dewatering cells/basins/ponds 112. In the illustrated embodiment, three cells 112 are shown, however, in other embodiments, one or more cells may be used. The dewatering cell/basin/ponds 112 can be formed of a number of materials including, but not limited to, dirt or compacted dirt, gravel or compacted gravel, soil or compacted soil, concrete, steel, or coal ash or compacted coal ash. The dewatering cells 112 can contain one or more features to help dewater the coal ash include, but are not limited to: i) liner; ii) leachate system; iii) vacuum system; iv) well points; and/or v) skimmers.

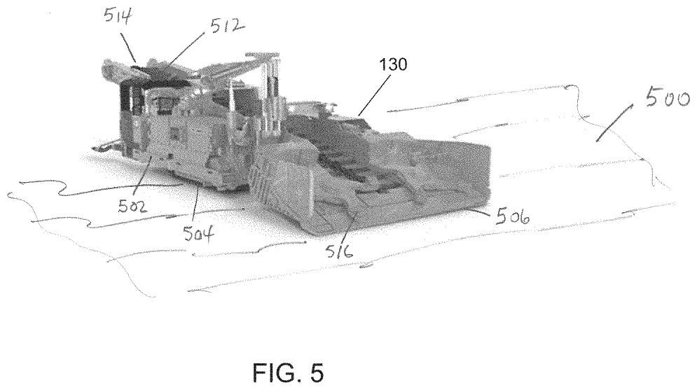

After the coal ash is dewatered to a predetermined moisture content in the dewatering cells 112, the ash (denoted by shading in the cells) can be removed by a loading process. In the illustrated embodiment, the loading process comprises using a continuous miner 114 feeding the coal ash into a conveyor apparatus 116. In other embodiments, the loading process can comprise using a continuous loader 130 (FIG. 5) and/or a continuous or non-continuous bulk solids handler including, but not limited to, an excavator, a front end loader, a ditching machine, a trenching machine, a snow blower or other bulk solids handler. The conveyor apparatus 116 (or other loading process) transports the dry coal ash to a solids loading junction 118 for transportation to a final location via truck, rail car, additional conveyors or conversion to coal ash paste. When the system 100 includes a solids removal plant 108, a secondary solids discharge line 120 can connect the solids removal plant to the solids loading junction 118 to transport the removed coal ash solids to the solids holding junction.

In some embodiments, a first water return line 122 is provided from the solids removal plant 108 to the original settling pond 102. The first water return line 122 is configured to return all or a portion of the water removed from the coal ash in the solids removal plant 108 to the original settling pond 102. In other embodiments, a second water return line 124 is provided from the designed dewatering cell/basin/pond 112 to the original settling pond 102. The second water return line 124 is configured to return the water removed from the coal ash in the dewatering cell/basin/pond 112 to the original settling pond 102. In still other embodiments, both the first and second water return lines 122 and 124 can be present. Returning the water removed from the coal ash in the solids removal plant 108 and/or in the dewatering cells 112 to the original settling pond 102 can reduce or eliminate the need to further treat the removed water to meet quality guidelines that would be necessary if the removed water was discharged to another location. The reduction or elimination of the need to further treat the removed water can result in great cost saving for the coal ash cleanup project.

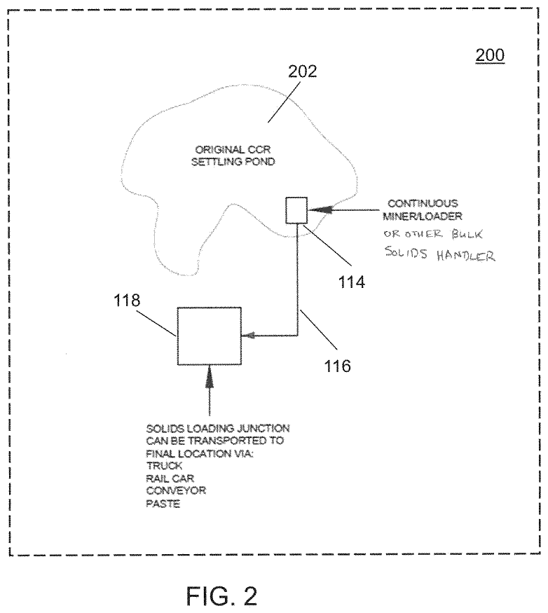

Referring now to FIG. 2, there is illustrated a schematic diagram of another system for coal ash cleanup 200 from an original settling pond 202. In this case, the original settling pond 202 contains a coal ash mixture that is dry enough to be handled as a solid. The system 200 of this embodiment includes a loading process that comprises using a continuous miner 114 feeding the coal ash directly from the original settling pond into a conveyor apparatus 116. In other embodiments, the loading process can comprise using continuous loaders 130, front end loaders or excavators and/or another continuous or non-continuous bulk solids handler. The conveyor apparatus 116 (or other loading process) transports the dry coal ash to a solids loading junction 118 for transportation to a final location via truck, rail car, additional conveyors or conversion to coal ash paste.

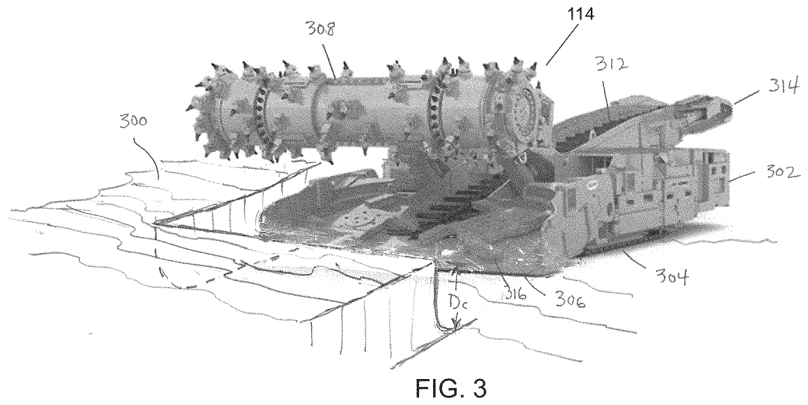

Referring now to FIG. 3, there is illustrated a continuous miner 114 that can be used in the previous embodiments of the system 100 or 200. One such continuous miner is the Joy 14CM27 continuous miner produced by Komatsu Mining Corp. Such continuous miners 114 were originally designed primarily for underground mining applications, but may be modified or adapted for use in the disclosed coal ash cleanup systems as described herein. In particular, remotely operated or autonomously operating continuous miners 114 can be used in some embodiments of the coal ash cleanup systems 100 and 200. The continuous miner 114 can include a body 302 mounted on flexible tracks (e.g., “caterpillar” tracks) 304 for good traction and low ground pressure as it drives on the bed of coal ash 300. An inlet scoop 306 can be mounted to the front of the body 302 and can be angle adjustable. A rotating reel 308 can also be mounted to the front of the body 302 and can be angle adjustable. By controlling the angle(s) of the inlet scoop 306 and/or rotating reel 308, the depth-of-cut (denoted D_{C}) can be selected controlled relative to the treads. This D_{C} determines the depth of the coal ash removed from the bed with each pass of the miner 114. The rotating reel 308 in the illustrated embodiment includes a plurality of cutting teeth 310; however, depending on the firmness of the coal ash to be loaded, other embodiments can use other solids removal implements on the reel including, but not limited to, paddles, scoops, buckets, scrapers and/or brushes. The miner 114 can further include a solids conveyor 312 running from the inlet scoop to a drop-off point 314. The solids conveyor 312 in the illustrated embodiment is a belt conveyor, but in other embodiments, the solids conveyor can be an auger or other type of solids transport mechanism. In the illustrated embodiment, the drop-off point 314 is positioned at the back end of the miner 114, but in other embodiments the drop-off point can be positioned on the side of the miner. In still other embodiments, the solids conveyor 312 can be angle adjustable in azimuth so the drop-off point 314 can be positioned within a range of angles relative to a centerline of the miner 114. The miner 114 can further be provided with one or more rotating arms 316 positioned within the inlet scoop 306 to push the coal ash onto the solids conveyor 312.

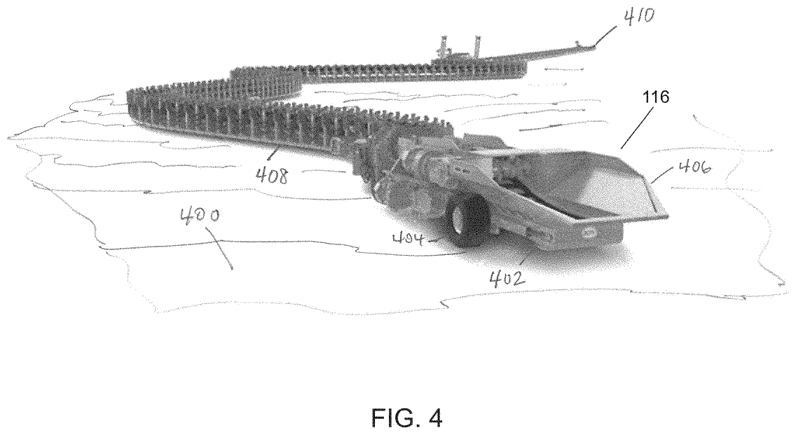

Referring now to FIG. 4, there is illustrated a flexible conveyor 116 that can be used in the previous embodiments of the system 100 or 200. One such flexible conveyor is the Joy 4FCT flexible conveyor train produced by Komatsu Mining Corp. Such flexible conveyors 116 can be used in conjunction with a continuous miner 114 or with other coal ash loading equipment and processes including, but not limited to continuous and non-continuous bulk solids handlers. Such flexible conveyors 116 were originally designed primarily for underground mining applications but may be modified or adapted for use in the disclosed coal ash cleanup systems. The flexible conveyor 116 can include a power end 402 including wheels 404 for supporting and moving the power end on the bed of coal ash 400. The power end 402 can include a hopper 406 for receiving the coal ash from a continuous miner 116, continuous loader 130, a front end loader, excavator and/or another continuous or non-continuous bulk solids handler (e.g., handlers 600 and 700). A flexible conveyor assembly 408 can extend from the power end 402 to terminal end 410. The flexible conveyor assembly 408 moves solids from the hopper 406 to the terminal end 410. In some embodiments, the power end 402 of the conveyor 116 is continuously moved to remain adjacent the loading apparatus (e.g., continuous miner 116, continuous loader 130 or other bulk solids handler) while the loading apparatus moves across the coal ash bed. In other embodiments, the power end 402 may be placed in the general locale of the loading apparatus and remains stationary as the loading apparatus moves. Then, one or more secondary bulk solids handlers such as front end loaders, dump trucks, or trailers 716 can bring the coal ash removed from the bed by the loading apparatus to the hopper 406 of the conveyor.

Referring now to FIG. 5, there is illustrated a continuous loader 130 that can be used in the previous embodiments of the system 100 or 200. In some embodiments, the continuous loader 130 can be used as an alternative to a continuous miner 114 or as a supplement to the continuous miner. One such loader is the Joy 14BU27 continuous loader produced by Komatsu Mining Corp. Such continuous loaders 130 were originally designed primarily for underground mining applications, but may be modified or adapted for use in the disclosed coal ash cleanup systems as previously described. In particular, remotely operated or autonomously operating continuous loaders 130 can be used in some embodiments of the coal ash cleanup systems 100 and 200. The continuous loader 130 can include a body 502 mounted on flexible tracks 504 for good traction and low ground pressure as it drives on the bed of coal ash 500. An inlet scoop 506 can be mounted to the front of the body 502 and can be angle adjustable. By controlling the angle of the inlet scoop 506 the depth-of-cut can be selected controlled relative to the treads. The loader 130 can further include a solids conveyor 512 running from the inlet scoop to a drop-off point 514. The solids conveyor 512 in the illustrated embodiment is a belt conveyor, but in other embodiments, the solids conveyor can be an auger or other type of solids transport mechanism. In the illustrated embodiment, the drop-off point 514 is positioned at the back end of the loader 130, but in other embodiments the drop-off point can be positioned on the side of the loader. In still other embodiments, the solids conveyor 512 can be angle adjustable in azimuth so the drop-off point 514 can be positioned within a range of angles relative to a centerline of the loader 130. The loader 130 can further be provided with one or more rotating arms 516 positioned within the inlet scoop 506 to push the coal ash onto the solids conveyor 512.

As described herein, some embodiments of the coal ash cleanup systems 100 and 200 utilize a continuous miner 114 and/or a continuous loader 130. Other embodiments utilize a continuous or non-continuous bulk solids handler including, but not limited to a conventional excavator, front end loader, ditching machine, trenching machine or snow blower. In other embodiments, new bulk solid handlers can be utilized that are either modified versions of conventional equipment or purpose-built bulk solids handlers configured for removing and transporting coal ash. Some embodiments of the new bulk solids handlers are described herein below.

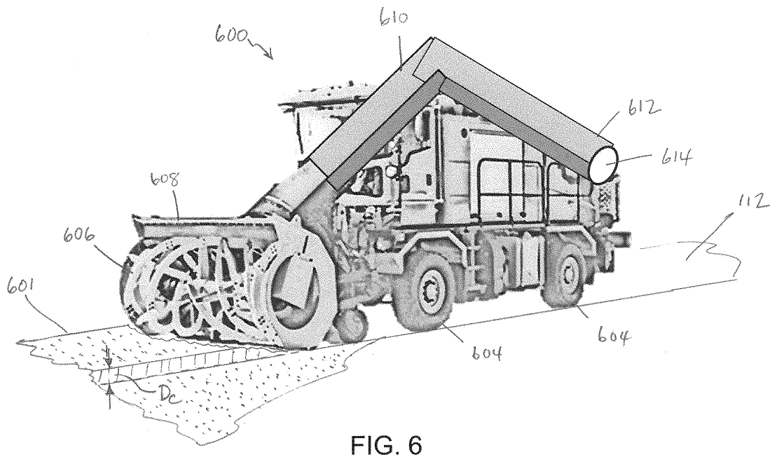

Referring now to FIG. 6, there is illustrated one bulk solids handler 600 that can be used to remove dewatered coal ash 601 in some embodiments the system 100 and/or 200. In the illustrated embodiment, the bulk solids hander 600 is a wheeled vehicle having a general layout similar to an Oshkosh Model 27K snow blower truck produced by Oshkosh Corporation of Oshkosh, Wis., USA. The handler 600 can include a body 602 mounted on low-pressure tires 604 to reduce the ground pressure on the dewatered coal ash as the handler moves across the surface of the coal ash 601 in the dewatering cells 112. In other embodiments of the handler 600, the body 602 can be mounted on rubber or metallic flexible tracks instead of the tires 604 for further reducing the ground pressure on the coal ash 601. A spiral auger 606 can be rotatably mounted in an auger housing 608 mounted to the front of the handler body 602. The auger housing 608 can be height-adjustably mounted to the front of the body 602 allowing the auger 606 to cut a selectable depth (denoted D_{C} in FIG. 6) into the dewatered coal ash 601. An elevator 610 can extend from a discharge port (not shown) at the back of the auger housing 608 to a discharge chute 612. The elevator 610 can be equipped with an internal conveyor or auger for lifting the coal ash from the discharge port to the discharge chute 612.

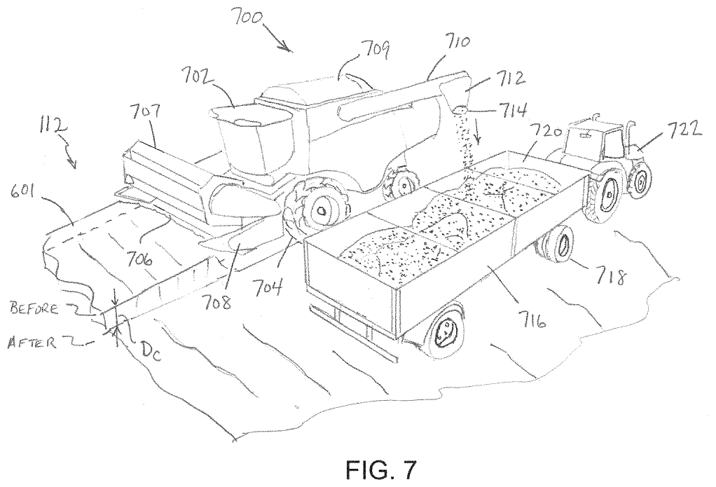

In use, the handler 600 can be driven across a bed of dewatered coal ash 601 in a dewatering cell 112. The height of the auger housing 608 can be adjusted to determine the depth-of-cut D_{C} of the auger 606 into the coal ash bed 601. The rotating auger 606 can push the coal ash 601 cut from the bed to the discharge port at the back of the auger housing 608. The coal ash then travels up the elevator 610 and then falls through the discharge chute 612 to the outlet 614. The coal ash falling from the outlet 614 of the handler 600 can be received by a conveyor apparatus 116 (FIG. 4), a moving transport trailer (FIG. 7) or another bulk solids handler to be finally transported from the dewatering cell 112.

Referring now to FIG. 7, there is illustrated another bulk solids handler 700 that can be used to remove dewatered coal ash 601 in other embodiments of the systems 100 and/or 200. In the illustrated embodiment, the bulk solids hander 700 is a wheeled vehicle having a general layout of a grain combine/harvester. The handler 700 can include a body 702 mounted on low-pressure tires 704 to reduce the ground pressure on the dewatered coal ash as the handler moves across the surface of the coal ash 601 in the dewatering cells 112. In other embodiments of the handler 700, the body 702 can be mounted on rubber or metallic flexible tracks instead of the tires 704 for further reducing the ground pressure on the coal ash 601. A cutter bar 706 and rotating reel 707 can be mounted in an intake housing 708 mounted to the front of the handler body 702. The cutter bar 706 serves to cut the coal ash 601 from the drying bed and the rotating reel 707 carries the coal ash to the rear of the intake housing 708. In some embodiments the cutter bar 706 can be a solid knife, whereas in other embodiments the cutter bar can be a reciprocating saw type mechanism. In some embodiments, the rotating reel 707 can include a plurality of buckets for carrying the coal ash into the intake, whereas in other embodiments the reel can include a plurality of other solids handling implements including, but not limited to, paddles, scoops, buckets, scrapers and/or brushes. The intake housing 708 can be height-adjustably mounted to the front of the body 702 allowing the cutter bar 706 to cut a selectable depth (denoted D_{C} in FIG. 7) into the dewatered coal ash 601. A lateral auger or conveyor (not shown) can be provided at the back of the intake housing for moving the coal ash from the intake housing 708 into the body 702. The body may contain an internal ash bin 709 for holding a quantity of coal ash for buffering purposes, i.e., for internal storage while changing transport trailers or while repositioning a conveyor. An elevator 710 can extend from the body 702 to a discharge chute 712. If an internal ash bin 709 is provided within the body 709, the elevator 710 may extend from the ash bin. The elevator 710 can be equipped with an internal conveyor or auger for lifting the coal ash from the body 702 or ash bin 709 to the discharge chute 712. An outlet 714 can be provided at the end of the discharge chute 712 for directing the coal ash to a conveyor or further bulk solids hander. In some embodiments, the elevation and/or angular position of the outlet 714 can be adjusted relative to the body 702. In some embodiments, the throughput of the elevator 710 extending between the coal ash bin 709 and the discharge outlet 714 can be adjusted to selectively increase or selectively decrease the quantity of coal ash stored in the coal ash bin. For example, slowing or stopping the speed of the internal auger of the elevator 710 can cause the quantity of coal ash delivered to the discharge outlet 714 to slow or stop while simultaneously increasing the quantity of coal ash stored in the bin 709. This is useful when changing or repositioning ash transporters to avoid dumping ash onto the ground. Once an available transporter is again in position, the speed of the internal auger can be increased to cause the quantity of coal ash delivered to the discharge outlet 714 to increase while simultaneously decreasing the quantity of coal ash stored in the bin 709.

In some embodiments, the bulk solids handler can further comprise one or more coal ash trailer 716 having a plurality of wheels 718 or tracks (not shown) and an open top body 720 for receiving coal ash from the bulk solids handler 600, 700 as the hander is moving. In some embodiments, the trailer 716 can be propelled by a separate prime mover 722 including, but not limited to, an agricultural tractor, construction tractor or a truck. In other embodiments, the trailer 716 can be self-powered vehicle including, but not limited to, a dump truck, side-tipper truck or live bottom truck.

In use, the handler 700 can be driven across a bed of dewatered coal ash 601 in a dewatering cell 112. The height of the intake housing 708 can be adjusted to determine the depth-of-cut D_{C} of the cutter bar 706 into the coal ash bed 601. The rotating reel 707 can push the coal ash 601 cut from the bed to the lateral auger/conveyor at the back of the intake housing 708, which pushes the coal ash into the body 702 or ash bin 709. The auger/conveyor in the elevator 710 lifts the coal ash to the top of the elevator, allowing it to fall through the discharge chute 712 to the outlet 714. The coal ash falling from the outlet 714 of the handler 700 can be received by a conveyor apparatus 116 (FIG. 4), a moving transport trailer 716 or another bulk solids handler to be finally transported from the dewatering cell 112. If the bulk solids handler 700 includes an internal ash bin 709 or other buffer, the handler can continue moving and collecting coal ash (which is stored in the bin) when the trailers 716 are being switched or when the conveyor apparatus 116 is being repositioned. After an empty trailer 716 is in position or the conveyor 116 is repositioned, the coal ash discharge rate of the elevator/discharge chute 710, 712 can be increased above the coal ash intake rate at the intake housing 708 to empty internal ash bin 709. This can allow for near-continuous operation of the bulk solids handler 700.

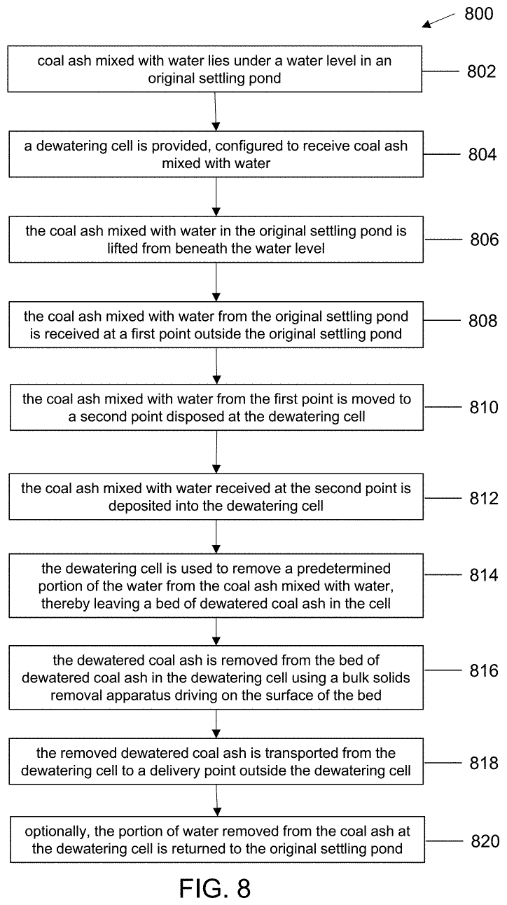

Referring now to FIG. 8, a flowchart is provided illustrating a method for cleanup of coal ash in accordance with another aspect. The method 800 begins at block 802, wherein the coal ash mixed with water lies under a water level in an original settling pond (e.g., pond 102 in FIG. 1). Proceeding to block 804, a dewatering cell (e.g., cell 112 in FIG. 1) is provided. The dewatering cell 112 is configured to receive coal ash mixed with water and can be disposed a distance from an original settling pond 102. The method proceeds to block 806, wherein the coal ash mixed with water in the original settling pond 102 is lifted from beneath a water level. This lifting can be performed using a dredge (e.g., dredge 104 in FIG. 1) or other slurry lifting mechanism. Proceeding to block 808, the coal ash mixed with water from the original settling pond is received at a first point outside the original settling pond. In some embodiments, the first point can be the inlet of a transport line (e.g., line 106 in FIG. 1). In other embodiments, the first point can be a solids separation plant (e.g., plant 108 in FIG. 1). Proceeding to block 810, the coal ash mixed with water from the first point is moved to a second point disposed at the dewatering cell 112.

The method 800 continues at block 812, wherein the coal ash mixed with water received at the second point is deposited into the dewatering cell 112. Proceeding to block 814, the dewatering cell 112 is used to remove a predetermined portion of the water from the deposited coal ash mixed with water, thereby leaving a bed of dewatered coal ash in the dewatering cell. Proceeding to block 816, the dewatered coal ash is removed from the bed of dewatered coal ash in the dewatering cell 112 using a bulk solids removal apparatus driving on the surface of the bed. The bulk solids removal apparatus can be at least one of a continuous miner 114, a continuous loader 130 or a bulk solids handler including, but not limited to, an excavator, a front end loader, a ditching machine, a trenching machine, a snow blower or other bulk solids handler (e.g., handlers 600 and 700). Proceeding to block 818, the removed dewatered coal ash (i.e., removed from the bed by the bulk solids removal apparatus) is transported from the dewatering cell 112 to a predetermined delivery point (e.g., solids delivery junction 118 in FIG. 1) outside the dewatering cell. Proceeding to block 820, optionally, some or all of the portion of water removed from the coal ash mixed with water at the dewatering cell 112 can be returned back to the original settling pond 102.

In some embodiments of the methods described herein, receiving the coal ash mixed with water from the original settling pond 102 at a first point outside the original settling pond further comprises: a) removing a first portion of the coal ash from coal ash mixed with water; b) discharging the removed first portion of the coal ash into a secondary solids line (e.g., line 120 in FIG. 1); and c) discharging the remainder of the coal ash mixed with water to the second point (e.g., using line 110 in FIG. 1). In some embodiments, the first point can be at a solids separation plant (e.g., plant 108 of FIG. 1). In some embodiments, removing a first portion of the coal ash from coal ash mixed with water at the first point, e.g., at plant 108, can be based on a predetermined size range of particles to be included in the first portion of the coal ash. In some embodiments, removing a first portion of the coal ash from coal ash mixed with water can include using solids removal equipment including, but not limited to, a bulk material screeners for rocks and debris, a screen unit, a trummel unit, a hydrocyclone, a centrifuge, a filter belt, a filter press or a chemical injector for coagulants or flocculents. This solids removal equipment can be located at the first point, e.g., at plant 108.

In some embodiments of the methods described herein, providing a dewatering cell can comprise constructing a water retaining structure at a site, wherein the structure is formed at least partially of at least one of dirt, gravel, clay, soil, compacted soil, concrete, steel, or coal ash brought to the site. In some embodiments, providing a dewatering cell can comprises constructing a water retaining structure including at least one of a liner; a leachate system, a vacuum system, a liquid removal well, or a liquid skimmer.

Although the preferred embodiment has been described in detail, it should be understood that various changes, substitutions and alterations can be made therein without departing from the spirit and scope of the invention as defined by the appended claims.

What is claimed is:

1. A system for cleanup of coal ash mixed with water from an original settling pond, wherein the coal ash lies under a water level in the settling pond, the system comprising the following:
a dredge configured to lift coal ash mixed with water in an original settling pond from beneath a water level;
a transport line configured to receive the coal ash mixed with water from the dredge and move the coal ash mixed with water out of the original settling pond;
at least one designed dewatering cell configured to receive the coal ash mixed with water from the transport line and remove a predetermined portion of the water from the received coal ash mixed with water to leave a bed of dewatered coal ash;
a bulk solids removal apparatus configured to drive on the bed of dewatered coal ash to remove the dewatered coal ash from the bed, the bulk solids removal apparatus being one of a continuous miner, a continuous loader or a bulk solids handler; and
a conveyor configured to receive the removed dewatered coal ash from the bulk solids removal apparatus and transport the dewatered coal ash to a predetermined delivery point outside the dewatering cell.

2. The system for cleanup of coal ash of claim 1, wherein the dredge is a hydraulic suction-type dredge.

3. The system for cleanup of coal ash of claim 1, wherein the dredge is a continuous bucket-type dredge.

4. The system for cleanup of coal ash of claim 1, further comprising a solids removal plant configured to receive the coal ash mixed with water from a first portion of the transport line, remove a first portion of the coal ash from coal ash mixed with water, to discharge the first portion of the coal ash into a secondary solids line, and to discharge the remainder of the coal ash mixed with water into a second portion of the transport line for delivery to the at least one designed dewatering cell.

5. The system for cleanup of coal ash of claim 4, wherein the solids removal plant is configured to remove the first portion of the coal ash from the coal ash mixed with water based on a predetermined size range of particles to be included in the first portion of the coal ash.

6. The system for cleanup of coal ash of claim 4, wherein the solids removal plant includes one or more of a bulk material screeners for rocks and debris, a screen and/or trummel unit, a hydrocyclone, a centrifuge, a filter belt, a filter press, and a chemical injector for coagulants or flocculents.

7. The system for cleanup of coal ash of claim 1, wherein the at least one designed dewatering cell is formed of one or more of dirt, gravel, soil, compacted soil, concrete, steel, or coal ash.

8. The system for cleanup of coal ash of claim 1, wherein the at least one designed dewatering cell further includes one or more of a liner; a leachate system, a vacuum system, a liquid removal well, and a liquid skimmer.

9. The system for cleanup of coal ash of claim 1, further comprising a water return line configured to return water removed from the coal ash in the at least one designed dewatering cell back to the original settling pond.

10. A method for cleanup of coal ash mixed with water from an original settling pond, wherein the coal ash lies under a water level in the settling pond, the method comprising the following:
providing a dewatering cell configured to receive coal ash mixed with water, the dewatering cell disposed a distance from an original settling pond;
lifting the coal ash mixed with water in the original settling pond from beneath a water level;
receiving the coal ash mixed with water from the original settling pond at a first point outside the original settling pond;
moving the coal ash mixed with water from the first point to a second point disposed at the dewatering cell;
depositing the coal ash mixed with water received at the second point into the dewatering cell;
removing, using the dewatering cell, a predetermined portion of the water from the deposited coal ash mixed with water and leaving a bed of dewatered coal ash in the dewatering cell;
removing the dewatered coal ash from the bed of dewatered coal ash in the dewatering cell using at least one of a continuous miner, a continuous loader or a bulk solids handler driving on the surface of the bed; and
transporting the removed dewatered coal ash from the dewatering cell to a predetermined delivery point outside the dewatering cell.

11. The method for cleanup of coal ash of claim 10, wherein receiving the coal ash mixed with water from the original settling pond at a first point outside the original settling pond further comprises:
removing a first portion of the coal ash from coal ash mixed with water,
discharging the removed first portion of the coal ash into a secondary solids line, and
discharging the remainder of the coal ash mixed with water to the second point.

12. The method for cleanup of coal ash of claim 11, wherein removing a first portion of the coal ash from coal ash mixed with water further comprises:
removing the first portion of the coal ash from the coal ash mixed with water based on a predetermined size range of particles to be included in the first portion of the coal ash.

13. The method for cleanup of coal ash of claim 11, wherein removing a first portion of the coal ash from coal ash mixed with water further comprises using at least one of a bulk material screeners for rocks and debris, a screen unit, a trummel unit, a hydrocyclone, a centrifuge, a filter belt, a filter press or a chemical injector for coagulants or flocculents.

14. The method for cleanup of coal ash of claim 10, wherein providing a dewatering cell further comprises:
constructing a water retaining structure at a site; and
wherein the structure is formed at least partially of at least one of dirt, gravel, clay, soil, compacted soil, concrete, steel, or coal ash brought to the site.

15. The method for cleanup of coal ash of claim 10, wherein providing a dewatering cell further comprises constructing a water retaining structure including at least one of a liner; a leachate system, a vacuum system, a liquid removal well, or a liquid skimmer.

16. The method for cleanup of coal ash of claim 10, further comprising returning the portion of water removed from the coal ash mixed with water at the dewatering cell back to the original settling pond.

17. A bulk solids handler for removing coal ash from a bed of dewatered coal ash, the handler comprising:
a body operably mounted on a set of wheels or tracks configured to move across a bed of dewatered coal ash;
a cutter apparatus operably attached to the front of the body and configured for cutting coal ash from the bed of dewatered coal ash as the body moves forward across the bed of dewatered coal ash;
an inlet scoop operably attached to the front of the body for receiving coal ash cut from the bed of dewatered coal ash; and
a solids conveyor system operably attached to the body for moving the coal ash from the inlet scoop to a discharge outlet, wherein the discharge outlet is configured for dumping the coal ash into an adjacent transport apparatus.

18. The bulk solids handler of claim 17, further comprising:
wherein at least one of the cutter apparatus and the inlet scoop is attached to the front of the body with an adjustable-angle mount defining a mounting angle; and
wherein selectively changing the mounting angle selectively changes a depth of cut into the bed of dewatered coal ash by the bulk solids handler.

19. The bulk solids handler of claim 17, wherein the cutter apparatus further comprises a rotating reel having a plurality of solids removal implements mounted thereon for removing coal ash from the dewatered coal ash bed and directing the removed coal ash into the inlet scoop.

20. The bulk solids handler of claim 17, wherein the solids conveyor system comprises:
a coal ash bin dispose within the body and configured to receive coal ash from the inlet scoop, the coal ash bin defining an internal storage volume for storing a quantity coal ash;
an elevator extending between the coal ash bin and the discharge outlet for moving coal ash from the coal ash bin to the discharge outlet; and
wherein the throughput of the elevator can be adjusted to selectively increase or selectively decrease the quantity of coal ash stored in the coal ash bin.
